(19) United States
(12) Patent Application Publication
(10) Pub. No.: US 2012/0193259 A1
(43) Pub. Date: Aug. 2, 2012

(54) METHOD AND APPARATUS FOR LABELED TOILETRIES

(76) Inventors: Paul Bahrami, New Hall, CA (US); Shehan James, Long Beach, CA (US)

(21) Appl. No.: 13/305,263

(22) Filed: Nov. 28, 2011

Related U.S. Application Data
(60) Provisional application No. 61/438,252, filed on Jan. 31, 2011.

(51) Int. Cl. G09B 21/00; B65D 85/00

(52) U.S. Cl. 206/459.5; 434/113

(57) ABSTRACT

One embodiment of a unique method of enabling hotels to provide visually impaired patrons the ability to use all toiletries typically found in a hotel bathroom is envisioned. Said method involves supplying a hotel with an assortment of all toiletries the hotel would need to fully stock their bathrooms in a visually impaired toiletry kit. Such a visually impaired toiletry kit would ensure that all hotel guests benefit equally from complementary conditioners, shampoos and other accompaniments supplied as a courtesy by the hotel.

### CROSS-REFERENCE TO RELATED APPLICATIONS

The present application claims priority to U.S. Provisional Patent Application Ser. No. 61/438,252 entitled METHOD AND APPARATUS FOR LABELED TOILETRIES, filed on Jan. 31, 2011, which is hereby incorporated by reference as to its entirety.

### BACKGROUND

The following is a tabulation of some prior art that presently appears relevant:

U.S. Patents

| Patent Number | Kind Code | Issue Date | Patentee |
|---|---|---|---|
| 5,720,616 | A | Feb. 24, 1998 | Schuler |
| 6,047,992 | A | Apr. 11, 2000 | Hampton |
| 6,267,374 | B1 | Jul. 31, 2001 | Bourbeau |
| 7,246,749 | B2 | Jul. 24, 2007 | Rumble |

### U.S. Patent Application Publications

Publication Number Kind Code Publ. Date Applicant
None found

### Foreign Patent Document

None found

### Nonpatent Literature Documents

None found

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

DISCUSSION OF THE RELATED ART

Various methods have been utilized for facilitating nonverbal communications with the visually impaired. The most common method of nonverbal communication with the visually impaired is Braille which is a widely used tactile method of communication. Braille is a six-position code of dots of two columns and three rows. Depending on the location and combination of the dots, letters, numbers, words or phrases are denoted. Where Braille is available, an individual can tactilely identify information placed on consumer products.

Braille is one of the only forms of tactile communication to be adapted for languages that do not use the Latin alphabet. Examples include Hebrew, Japanese, Korean, and Chinese Braille. All these Latin-derived forms of Braille rely on a similar six dot cell. The combination of raised and lowered dots within a cells indicates to the reader what letter of the alphabet they are touching.

Most hotels and temporary residences accommodate their clients by offering basic toiletries throughout the travelers stay. Such accommodations include small bars of soap, shower caps, small bottles of moisturizer, small bottles of shampoo and conditioner, toilet paper, mouthwash, boxes of tissue, and disposable shoe polishing clothes.

In the past, numerous methods have been suggested to identify the contents of miniature toiletry bottles. However all of these methods have limitations which make them unsuitable for the visually impaired hotel guest:
(a) The known labeling systems not using raised characters are of no assistance as identifiers to the visually impaired;
(b) The known labeling systems using raised characters are limited to Latin characters;
(c) The known labeling systems do not use Braille;
(d) The known labeling systems are not cable of identifying to the visually impaired any toiletries other than shampoo and conditioner;
(e) The known labeling systems are not adapted to be integral parts of the toiletry container;

Therefore, there is a need for a system of labeling toiletries which utilizes Braille to facilitate the visually impaired in identifying the contents of those miniature toiletries commonly found in hotels. Such a system may be an integral part of the toiletry container to ensure that the labels do not peel off when the containers get wet. The present invention effectuates these needs.

### SUMMARY

In accordance with one embodiment, a unique method of enabling hotels to provide visually impaired patrons the ability to use all toiletries typically found in a hotel bathroom is envisioned. Said method involves supplying a hotel with an assortment of all toiletries the hotel would need to fully stock their bathrooms in a visually impaired toiletry kit.

In one embodiment, said kit would be comprised of shampoo, conditioner, moisturizer, mouthwash, and liquid soap each contained in separate miniature containers with respective content bearing indicia written in Braille on the outside of said container. In this embodiment, the miniature bottle containing shampoo would have the word “shampoo” written in Braille on the outside of the container. The bottle containing liquid soap would have the word “soap” written in Braille on the outside of the bottle. And so on and so forth.

Such a visually impaired toiletry kit would ensure that all hotel guests benefit equally from complementary conditioners, shampoos and other accompaniments supplied as a courtesy by the hotel. Blind travelers will no longer be troubled with issues associated with having to bring all their own toiletries whenever they leave their homes. Given the more stringent government regulations involving liquids carried by passengers on airplanes, the types of packaging they must be contained in, and limitations on the quantity, said toiletry kit would have a substantial impact on visually impaired travelers who fly to their destinations.

Moreover, the use of Braille to describe the contents of a miniature toiletry means that the containers can be quickly and easily adapted for use all over the world. As mentioned above, many languages with Latin characters use Braille. By modifying the dot-cell combinations on the outside of the toiletry containers, the bottles can be adapted for use in hotels all around the world. Therefore it is envisioned that in one embodiment of the visually impaired toiletry kit, the contents of the shampoo, conditioner, liquid soap, moisturizer and other toiletries typically found in a hotel guest bathroom can be written in forms of Braille including, but not limited to, Hebrew, Japanese, Korean, and Chinese Braille.

It is further envisioned that in another embodiment of the visually impaired toiletry kit the Braille content description may be integrally attached to the container. For example, the word “shampoo” outside of the miniature shampoo bottle may be written in Braille with the dots molded into the bottle. In yet another embodiment, this will be made possible through the use of a mold with Braille raised dots.

### Advantages

Thus several advantages of one or more aspects are to provide:
(a) a kit for enabling hotel operators to accommodate the personal hygiene needs of more patrons,
(b) a kit which will allow the visually impaired to quickly and easily identify and distinguish between various toiletries commonly found in a hotel bathroom,
(c) a kit which contains a plurality of miniature toiletries each containing a description of the contents written in Braille on the outside of the container,
(d) a kit in which all of the toiletries contained therein have the entire word describing the bottle contents spelled out in Braille,
(e) a kit in which the Braille content identifications are integrally attached to the individual containers,
(f) a system which will allow miniature bottle manufacturers to have integral labels for the visually impaired and conveniently switch between manufacturing bottles labeled in one language to another (as in going from English Braille to Japanese Braille while using the same raised dot cells to spell out complete content descriptions as opposed to switching from Latin characters to Japanese Hiragana).

These and other advantages of one or more aspects will become apparent from consideration of the ensuing description and accompanying drawings. Although the description above contains many specificities, these should not be construed as limiting the scope of the embodiments but as merely providing illustrations of some of several embodiments. For example, the integral Braille labels may be in English Braille in one embodiment and in Spanish Braille in another. The Braille dot cell system can be used to facilitate reading for the visually impaired in a variety of different languages making it a useful tool for hotel operators and miniature toiletry manufacturers. Thus the scope of the embodiments should be determined by the claims that are appended and their legal equivalents, rather than by the examples given.

The description of the invention which follows, together with the accompanying drawings should not be construed as limiting the invention to the examples shown and described, because those skilled in the art to which this invention pertains will be able to devise other forms thereof within the ambit of the appended claims.

### DESCRIPTION OF THE DRAWINGS

### Figures

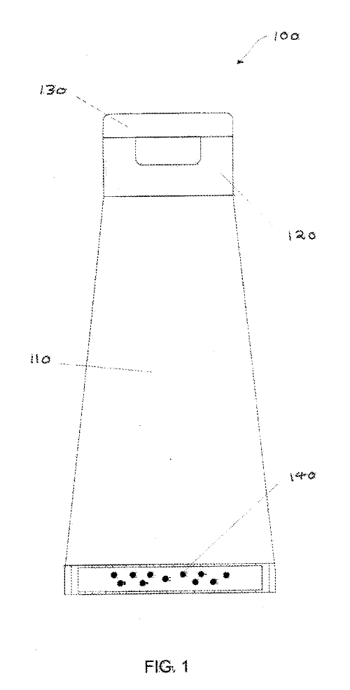

FIG. 1 is a front view of a labeled toiletry;

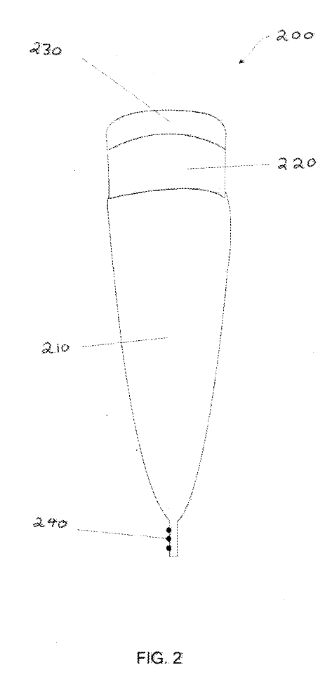

FIG. 2 is a side view of a second labeled toiletry;

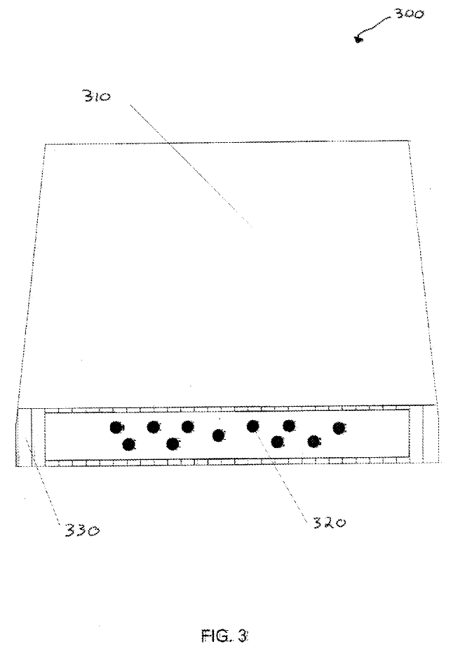

FIG. 3 is a front view of a third labeled toiletry; and

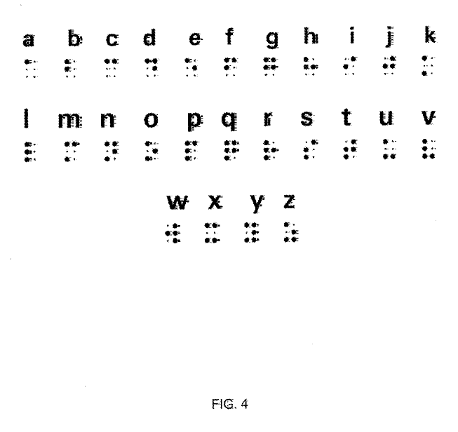

FIG. 4 is a chart illustrating the Braille alphabet with Latin characters;

Reference Numerals

| | | | |
|---|---|---|---|
| 100 | labeled toiletry | 110 | tube |
| 120 | top | 130 | cap |
| 140 | Braille labeling | 200 | second labeled toiletry |
| 210 | second tube | 220 | second top |
| 230 | second cap | 240 | second Braille labeling |
| 300 | third labeled toiletry | 310 | third tube |
| 320 | third Braille labeling | 330 | bottom sealed portion |

### DETAILED DESCRIPTION

Illustrative embodiments of the invention are described below. The following explanation provides specific details for a thorough understanding of an enabling description for these embodiments. One skilled in the art will understand that the invention may be practiced without such details. In other instances, well-known structures and functions have not been shown or described in detail to avoid unnecessarily obscuring the description of the embodiments.

One embodiment of the method and apparatus for labeled toiletries is illustrated in FIGS. 1,2,3 and 4. One embodiment encompasses a unique method of providing blind traits and abilities to differentiate between different types of toiletries provided to them by hotel or other establishment.

Each toiletry container can be manufactured with the Braille or raised lettering as part of the container, or can be placed on the container afterwards. For example, it may be more feasible to create all of the containers at once without differentiating them, and later labeling them according to the appropriate toiletry that is placed inside. The containers are typically three inches tall, two inches wide, and one inch deep, and typically can hold one ounce or less, but the size can vary from these dimensions.

The materials for the containers comprise plastic, rubber, glass, flexible metals, or any other suitable material. The containers may be coated with a material to provide better grip or to protect the contents. The shape of the containers can vary from a simple tube to a capped bottle to a pump bottle. The placement of the lettering can be on the body of the container, on the top cap of the container, or on the sealed portion of the container. A label can be placed on the container, and the label can comprise the Braille or raised lettering as opposed to the container itself.

FIG. 1 illustrates one embodiment of the front of a labeled toiletry 100. The label toiletry 100 comprises a tube 110, a top 120, and a cap 130. The Braille labeling 140 is placed on the container on the exterior where an individual will have little difficulty identifying the type of toiletry they would like to use. While this is one embodiment, containers of many different shapes and sizes may be used.

FIG. 2 illustrates the side of one embodiment of a labeled toiletry 200. The labeled toiletry 200 in FIG. 2 comprises a tube 210, a top 220, and a cap 230. The Braille labeling 240 is placed on the exterior where an individual will have little difficulty identifying the type of toiletry they would like to use. While this is one embodiment, containers of many different shapes and sizes may be used.

FIG. 3 illustrates the front view of one embodiment of a labeled toiletry 300. The labeled toiletry 300 comprises a tube 310 with Braille labeling 320. The labeling 320 can be placed on the bottom sealed portion 330 of the tube as pictured, or on any other part of the labeled toiletry 300. It is envisioned that the labeling 320 will be located on the bottle in an area where an individual will be able to quickly and easily determine the contents of a particular toiletry bottle.

FIG. 4 is a chart illustrating the Braille alphabet with Latin characters. The words “soap,” “shampoo,” and “lotion” may be created by combining the appropriate characters and placing them onto the containers. Any other appropriate labels can also be used by spelling out the appropriate indicia to differentiate the various types of toiletries.

### CONCLUSIONS, RAMIFICATIONS, AND SCOPE

While a particular form of the invention has been illustrated and described, it will be apparent that various modifications can be made without departing from the spirit and scope of the invention. For example, the miniature bottles may be made from plastic or a variety of different materials. Accordingly, is not intended that the invention be limited, except as by the appended claims.

The teachings provided herein can be applied to other systems, not necessarily the system described herein. The elements and acts of the various embodiments described above can be combined to provide further embodiments. All of the above patents and other references, including any that may be listed in accompanying filing papers, are incorporated herein by reference. Aspects of the invention can be modified, if necessary, to employ the systems, functions, and concepts of the various references described above to provide yet further embodiments of the invention.

Particular terminology used when describing certain features or aspects of the invention should not be taken to imply that the terminology is being refined herein to be restricted to any specific characteristics, features, or aspects of the toiletry set with which that terminology is associated. In general, the terms used in the following claims should not be constructed to limit the toiletry set to the specific embodiments disclosed in the specification, unless the above Detailed Description section explicitly define such terms. Accordingly, the actual scope encompasses not only the disclosed embodiments, but also all equivalent ways of practicing or implementing the disclosed toiletry set. The above detailed description of embodiments of the toiletry set is not intended to be exhaustive or limited to the precise form disclosed above or to a particular field of usage. While specific embodiments of, and examples for, the toiletry set are described above for illustrative purposes, various equivalent modifications are possible which those skilled in the relevant art will recognize.

While certain aspects of the toiletry set are presented below in particular claim forms, the inventor contemplates the various aspects of the toiletry set in any number of claim forms. Accordingly, the inventor reserves the right to add additional claims after filing the application to pursue such additional claim forms for other aspects of the toiletry set.

What is claimed is:

1. A system to aid the visually impaired in identifying hotel toiletries comprising:
a first, second, and third set of Braille cells, said first set of Braille cells configured to spell out the word “shampoo,” said second set of Braille cells configured to spell out the word “conditioner,” said third set of Braille cells configured to spell out the word “soap,”;
a miniature shampoo container having a side, a miniature conditioner container having a side, and a miniature liquid soap container having a side; and
said first set of Braille cells being integrally attached to said shampoo container such that the word “shampoo” extends outwardly from the side of said shampoo container, said second set of Braille cells being integrally attached to said conditioner container such that the word “conditioner” extends outwardly from the side of said conditioner container, said third set of Braille cells being integrally attached to said liquid soap container such that the word “soap” extends outwardly from the side of said liquid soap container.

2. The system of claim 1 further comprising a fourth set of Braille cells, said fourth set of Braille sells configured to spell out the word “lotion,”;
a miniature lotion container having a side;
said fourth set of Braille cells being integrally attached to said lotion container such that the word “lotion” extends outwardly from the side of said lotion container.

3. The system of claim 1 further comprising a fifth set of Braille cells, said fifth set of Braille sells configured to spell out the words “mouth wash,”;
a miniature mouth wash container having a side;
said fifth set of Braille cells being integrally attached to said mouth wash container such that the words “mouth wash” extend outwardly from the side of said mouth wash container.

4. A visually impaired toiletry kit comprising:
a miniature shampoo container with a side, a first set of Braille cells configured to spell out the word “shampoo,” said first set of Braille cells being integrally attached to said shampoo container such that the word “shampoo” extends outwardly from the side of said shampoo container;
a miniature conditioner container with a side, a first set of Braille cells configured to spell out the word “conditioner,” said first set of Braille cells being integrally attached to said conditioner container such that the word “conditioner” extends outwardly from the side of said conditioner container; and
a miniature liquid soap container with a side, a first set of Braille cells configured to spell out the word “soap,” said first set of Braille cells being integrally attached to said liquid soap container such that the word “soap” extends outwardly from the side of said liquid soap container.

5. A miniature lotion container with a side, a first set of Braille cells configured to spell out the word “lotion,” said first set of Braille cells being integrally attached to said lotion container such that the word “lotion” extends outwardly from the side of said lotion container.

6. A miniature mouth wash container with a side, a first set of Braille cells configured to spell out the words “mouth wash,” said first set of Braille cells being integrally attached to said mouth wash container such that the words “mouth wash” extends outwardly from the side of said lotion container.
